(19) United States
(12) Patent Application Publication
(10) Pub. No.: US 2003/0177149 A1
(43) Pub. Date: Sep. 18, 2003

(54) System and method for data backup

(76) Inventor: David Lawrence Coombs, Toronto (CA)

Correspondence Address: OGILVY RENAULT, 1981 MCGILL COLLEGE AVENUE, SUITE 1600, MONTREAL, QC, H3A2Y3, CA

(21) Appl. No.: 10/098,553

(22) Filed: Mar. 18, 2002

(51) Int. Cl. G06F 12/16

(52) U.S. Cl. 707/204; 711/162; 714/6

(57) ABSTRACT

A method and system of data backup for a computer system is disclosed. Full and incremental backups of data stored to a first storage device coupled to the computer system are stored to a backup storage device coupled to the computer system. Data representative of the relationship of each incremental backup to its respective parent backup is stored in a dependency data structure, preferably a tree-like structure. Different types of incremental backups may be performed to provide different data granularity. When two or more storage media are used in a rotational manner, each medium always contains a complete backup. The backup storage device is automatically managed by paring at least one of a full and incremental backup at the backup storage device automatically in accordance with a plan. The plan is preferably configured to manage an amount of available storage space at the backup storage device. When restoring data from a backup, data to be restored that is stored in a parent backup is automatically located and restored.

### TECHNICAL FIELD

This application relates to the backup of data in a data processing system, including backup data management and restore.

### BACKGROUND OF THE INVENTION

An integral part of modern data processing systems is data storage by means of data storage devices and storage media. Such devices and media particularly include devices with high-capacity random read-write capabilities such as hard disk drives and their disks. Hard disks can fail at any time, and indeed all will fail eventually as their components wear out. Power surges and other environmental factors can destroy storage devices. Moreover, users can destroy data: they can accidentally delete important files or knock servers over, destroying the hardware within. Sometimes, the data is recoverable. Often, some, most, or all of the damage is irreparable.

Preventative measures such as better power regulation or improved hardware product quality can reduce the risk of catastrophic failures. But such measures cannot eliminate the risk of data loss.

It is a well known technique to further lessen the risk of loss of data by adopting a redundancy policy, periodically backing up data stored on a primary data storage device to another storage device for safe-keeping. If the data is regularly copied to another storage device, a recent copy can be restored in the event that the data is lost from the primary storage device.

Modern systems, especially those that contain the data of many users, almost always have backup systems. But these systems can often be tedious: they can be slow and complex, requiring significant user intervention. The backed up data is sometimes less than complete. Often, as a result, users fail to diligently backup the data storage devices.

Determining which files to restore from a collection of backup data can be particularly difficult as well. The backup files of a single user may be spread over many backup media necessitating the location and loading of each media and the restoration of the desired files.

What is therefore desired is a data backup system and method that remedies these problems and which is simple to set up and operates quickly and reliably.

### SUMMARY OF THE INVENTION

It is an object of the invention to provide a method and system of data backup.

In accordance with the invention, in one aspect there is provided a method of data backup of data stored in a first storage device coupled to a computer system. The method comprises steps of storing to a backup storage device coupled to the computer system at least one full backup. Each full backup comprises a copy of the data selected from the first storage device in accordance with a first criteria and attribute data representative of attributes of the selected data. A further step comprises storing to the backup storage device zero, one or more incremental backups where each incremental backup is a copy of data selected from the first storage device in accordance with the first criteria and a second criteria and attribute data representative of attributes of the selected data. The second criteria is determined in relation to a parent backup to the incremental backup where the parent backup comprises one of a selected full backup and incremental backup previously stored to the backup storage device. A further step comprises storing in a dependency data structure parent data representative of the relationship of each incremental backup to its respective parent backup. Preferably the data dependency structure is a tree-like structure.

The method may also comprise periodically performing the storing steps in accordance with two or more time intervals and respective second criteria to store different incremental backup types to provide different data granularity. Preferably, the data dependency structure is stored to the backup storage device.

In accordance with a feature of the method, the backup storage device may be operable with one or more storage media. As such, the method described may comprise the steps of providing at least two storage media and the storing using said at least two storage media in a rotational manner. Further, for each incremental backup to be stored to a one of the storage media, the second criteria is determined in relation to a parent backup stored to the one of the storage media.

Preferably the method includes a verification step to verify the storing of the selected data stored to the backup storage device 24. Additionally, the backup process preferably includes a compression step to compress a backup prior to a final storing to the backup storage device 24. The backup may be prepared as described herein and the backup compressed in blocks of bytes, for example 256K byte blocks, in accordance with conventional compression techniques understood to persons skilled in the art.

In accordance with an aspect of the invention, the method thus described may include steps to manage the backups stored to the backup device automatically in accordance with a plan. The plan preferably balances the desire to maintain the availability of data backups with the need for storage space for additional data backups. Accordingly, the method preferably includes the step of paring at least one of a full and incremental backup at the backup storage device automatically in accordance with a plan to manage the full and incremental backups. The plan may be configured to manage an amount of available storage space at the backup storage device.

In accordance with a yet another aspect of the invention, the method thus described may include steps to facilitate the restoration of data stored to the backup storage device. The data may be restored to a second storage device coupled to the computer system. Persons skilled in the art understand that the second storage device may comprise the first storage device from which the data was originally backed up. The method preferably includes the steps of identifying a backup stored to the backup storage device comprising data to be restored to the second storage device. This backup defines a current backup. The data to be restored to the second storage device may be copied from the data stored to the current backup. Until all the data to be restored is copied to the second storage device, the following steps may be repeated. The portion of the data to be restored remaining to be copied is determined. A parent backup to the current backup from the dependency data structure is determined and the parent backup redefines the current backup. Where the data stored to the current backup comprises any of the portion of the data to be restored remaining to be copied, the any of the portion of data is copied to the second storage device from the current backup.

In still other aspects of the invention, there is provided a computer system and a computer program product configured accordingly.

### BRIEF DESCRIPTION OF THE DRAWINGS

Further features and advantages of the present invention will become apparent from the following detailed description, taken in combination with the appended drawings, in which:

FIG. 1 is a block diagram of a data backup management and restore system in accordance with an embodiment of the invention;

FIG. 2 illustrates a sample dependency structure for organizing backups in accordance with the present invention; and

FIGS. 3 and 4 are flow diagrams of operational steps of the backup system and method of the present invention;

It will be noted that throughout the appended drawings, like features are identified by like reference numerals.

### DETAILED DESCRIPTION OF THE PREFERRED EMBODIMENT

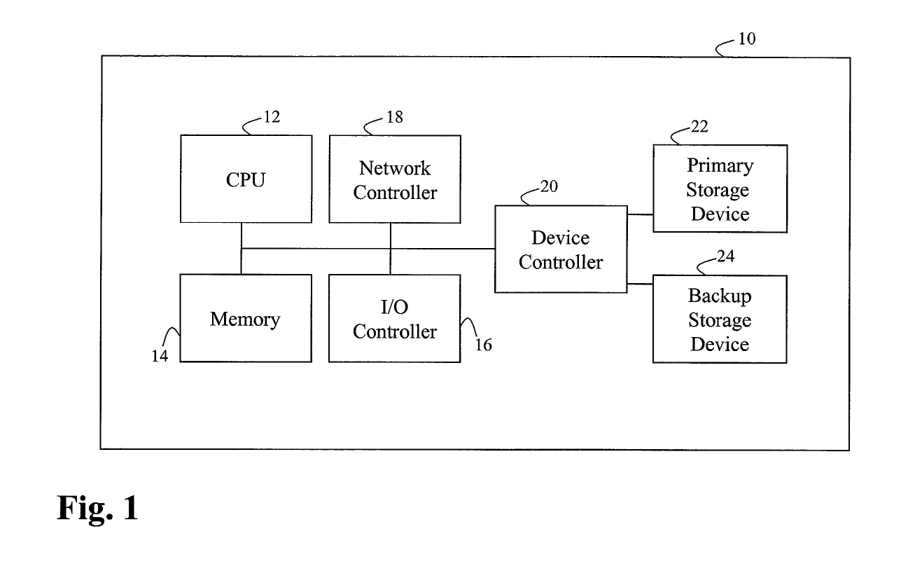

FIG. 1 illustrates, in block diagram form, an exemplary computer system 10 for digital data processing configured for data backup, management and restore capabilities in accordance with an embodiment of the invention. Computer system 10 includes a central processing unit (CPU) 12 coupled to memory 14, such as random access memory (RAM), read only memory (ROM), programmable ROM and the like. CPU 12 is also coupled to an input/output (I/O) controller 16 for controlling one or more input and/or output devices (not shown), a network controller 18 for network communication with one or more other computer systems (not shown) and a storage controller 20 for communication with a primary storage device 22 and a backup storage device 24.

Computer system 10 may be a multi-user or single-user system, including a server, mainframe, personal computer (PC), workstation, laptop, or the like. Each of primary storage device 22 and backup storage device 24 includes rewriteable media such as a fixed disk drive, mountable (i.e. selectively removable) disk drive, disk drive array or other rewriteable media, though magnetic tape or other sequential media are not preferred.

The exemplary computer system 10 is a generalized system as is understood to persons skilled in the art. Numerous modifications will be apparent. For example, primary storage device 22 and backup storage device 24 may be connected to separate controllers (e.g. integrated device (or drive) electronics (IDE) controllers) or with both devices 22 and 24 connected to the same IDE controller in a master and slave relationship. The controller may be in accordance with the small computer system interface (SCSI) standard, enhanced IDE (EIDE) standard or any other method of connecting storage devices to computers.

Computer system 10 may include further storage devices and respective controllers therefor such as a floppy disk drive, a CD-ROM drive, a tape drive, flash disk drive (all not shown). Additionally, computer system 10 may include a plurality of I/O controllers for a variety of I/O devices such as a keyboard, display screen, pointing device, etc. While only a single CPU 12 is illustrated, a multi-processor configuration may be employed as is well known to those skilled in the art.

While primary storage device 22 and backup storage device 24 are shown as included within computer system 10, one or both of the primary and backup storage devices 22 and 24 may be coupled to computer system 10 via network communication through network controller 18. For example, computer system 10 may comprise a server system having a local primary storage device 20 comprising a redundant array of independent (or inexpensive) disks (RAID) device. Backup storage device 24 may comprise a larger capacity RAID device resident at a remote computer system (not shown) coupled to server system 10 via a high-speed network (not shown). A RAID provides relatively convenient, low-cost, and highly reliable storage by saving data on more than one disk simultaneously.

In a preferred embodiment, CPU 12 is a general purpose processor such as an AMD Athlon™ processor from Advanced Micro Devices, Inc. or Intel Pentium™ processor from Intel Corporation running under the control of a LINUX operating system (LINUX is a trademark of Linus Torvalds) (not shown). Computer system 10 includes a conventional file system and, typically, one or more application programs in a conventional configuration (all not shown). In the preferred embodiment discussed herein, backup processes, management processes and restore processes are performed by CPU 12 under the control of software prepared in accordance with the invention disclosed herein to backup data stored on primary storage device 22 to backup storage device 24, manage the backup data on backup storage device 24 and restore the backup data.

A primary storage device such as device 22 typically contains two general data types, namely system files and user files. Once loaded and configured via one or more system configuration files, most system files rarely change over time. Preferably, the system files may be coupled to computer system 10 via a separate storage device such as a 32 Mb flash disk available from SimpleTech, Incorporated of Santa Ana, Calif. Conveniently, such storage devices provide quick access times for transferring data to CPU 12 and are primarily read-only in nature thus reducing the need for backup. Any system configuration files may be stored on primary storage device 22 to permit changes to the configuration and to facilitate convenient backup with other user files.

In accordance with a preferred practice of the invention, the backup process coordinates periodic “full” (i.e. non-incremental) and “incremental” backups of the one or more system configuration files and the user files from primary storage device 22 to backup storage device 24. A full backup is a copy at a particular point in time of all the files to be backed up from primary storage device 22. An incremental backup is a copy at a particular point in time of data files to be backed up from primary storage device 22 and that were changed or added to primary storage device 22 subsequent to a previous backup. The incremental backup may be performed relative to a full backup or an another incremental backup as is well understood by persons skilled in the art. Moreover, the previous backup from which an incremental backup is based need not be the most recent backup as will be explained further below.

In order to lessen user burden, preferably the software for coordinating the backup process may be pre-configured to define certain default parameters indicating, for example, which system configuration files and user files are to be backed up and the respective periods for the one or more types of full and incremental backups. User input may be enabled to configure the frequency (i.e. periodic time intervals) of the full and incremental backups or the specific day or time of day for the performance of such backups as described further below.

In accordance with a preferred practice of the invention, a full backup is automatically configured for performance once per month and is hereinafter referred to as a “monthly” backup. A user may select a preferred day of the month and/or time of day for the commencement of the monthly backup though this parameter may be pre-configured with a default setting. Three types of incremental backups are predefined, namely “weekly”, “daily” and “micro” incremental backups. A weekly backup uses the most recent monthly backup as a parent (i.e. base) backup. That is, anything changed since the last monthly backup is backed up in the weekly backup. A weekly backup is performed after seven days as described below.

Once a day, an incremental daily backup is performed using the most recent weekly or monthly backup as a parent. If a weekly backup is not available, such as at the early stages of the backup process before the end of the first week, a monthly backup may be used as the parent of a daily backup. User input may also be permitted to enable the selection of the time of day for such a daily backup, for example, late at night or otherwise during an expected low usage period for CPU 12.

Additionally, at a user-defined interval, if none of the above three situations applies, an incremental micro backup is performed using the most recent backup (either micro, daily, weekly or monthly) recorded on backup storage device 24 as a parent. The micro backup interval may be selected according to user preference and is preferably pre-configured to a default setting such as every 15 minutes.

For example, Table 1 shows chronologically how backup dependencies are formed including how initial daily backups are based on the first monthly backup. The sequence of backups in Table 1 assumes that backups do not get deleted. The delete feature of the management process is described further below.

TABLE 1

| Backup # | Parent is # | Type |
|---|---|---|
| 1 | (no parent) | Monthly |
| 2 | 1 | Micro |
| 3 | 2 | Micro |
| 4 | 3 | Micro |
| — | — | Micro |
| 97 | 1 | Daily |
| 98 | 97 | Micro |
| 99 | 98 | Micro |
| — | — | Micro |
| 193 | 1 | Daily |
| 194 | 193 | Micro |
| | | (Micro/Daily |
| | | as |
| | | applicable) |
| 673 | 1 | Weekly |
| 674 | 673 | Micro |
| — | — | Micro |
| 769 | 673 | Daily |
| 770 | 769 | Micro |
| — | — | — |
| 2689 | (no parent) | Monthly |

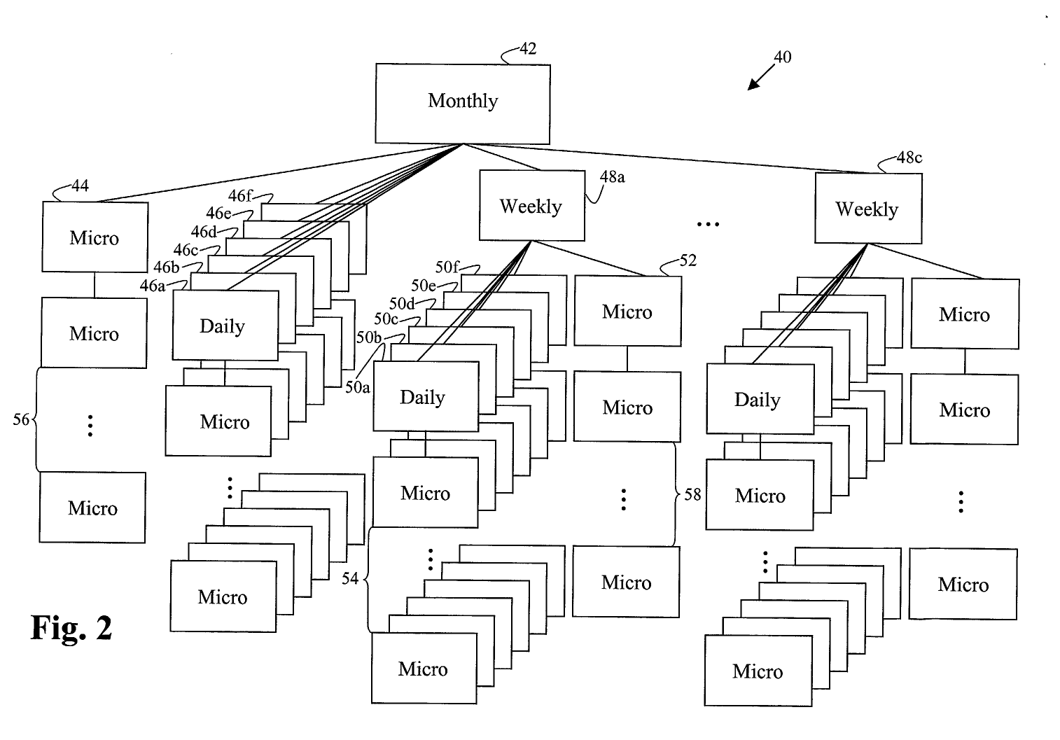

Referring to FIG. 2, there is illustrated in graphical form a sample backup dependency structure in accordance with the present invention. The backup dependency structure for a 28-day notional month of backups is depicted as a tree 40 having a plurality of nodes each representing an individual full or incremental backup. A node is connected to another node by an edge denoting a parent/child dependency between the joined nodes whereby a child node depends from a parent node if the parent node represents a base backup for the backup represented by the child node. While a full backup interval such as the notional month having a consistent number of days is convenient to implement, a full backup interval may be implemented to coincide with calendar months or another time period such as a quarter of the year, fortnight, etc.

Tree 40 includes monthly root node 42 representing a full backup. This monthly backup is the base for a plurality of incremental backups represented by micro node 44 for the first day's backups, six subsequent daily nodes 46a, 46b, 46c . . . 46f representing the remaining six days of the first week, and three weekly nodes 48a, 48b (not shown) and 48c for the final three weeks of the 28 day month. Each of the foregoing incremental micro, daily and weekly backup nodes are root nodes of respective sub-trees representing backup activities for respective days and weeks of the month. For example, from weekly node 48a depends six daily nodes 50a, 50b, 50c . . . 50f and a micro node 52. Daily node 50a is a parent for a chain of 95 micro backups (collectively designated 54). Similarly, the other daily nodes are respective parents to other chains of 95 micro backups. Micro nodes 44 and 52 are respective parent nodes of two chains of 94 micro nodes (respectively collectively designated 56 and 58). At the end of the month, assuming no deletions, there is one monthly backup, three weekly backups, 24 daily backups, and 2660 micro backups. Any particular backup may be selected and restored in whole or part as described further below.

Structuring the backup dependencies in a tree-like structure facilitates convenient backup, restore and paring (i.e. deletion of the backup and its removal from the tree structure) when the backups are deemed unnecessary or once the backup storage device is full, without sacrificing a comprehensive set of backups. Other structures for organizing the various backups in accordance with the dependency of each backup may be envisioned by those skilled in the art.

The backup process is configured to operate as follows. Initially, the type of backup is determined. If the type is an incremental backup, the parent backup therefor is determined from the dependency data structure. The parent backup is read from device 24 to retrieve its index (i.e. signals representative of attributes of the data comprising the backup where the attributes include a list of all files and their respective file attributes as described further below). The reference to file herein includes directory or folder or such other structure for storing and organizing data in files. The list of files from the retrieved index, along with the last-changed time file attribute for each file are useful for determining which files are to be stored in a new incremental backup. If the backup type is a full backup, it is not necessary to determine the parent backup.

Whether performing a full or incremental backup, the entire file structure at the primary data storage device is scanned to establish a list of every file and their file attributes, such as, last-changed time, size, permission attributes, owner and group identifiers, and any implementation-specific flags that may be desired for constructing a backup index. To store the backup on device 24, a backup header, including, for example, a name of the computer system and/or primary storage device being backed up, backup date/time, backup software version, and other attribute indicators is prepared and written to the device. The index of files determined from the scan may be traversed to locate appropriate files and directories for backup. For a full backup, the contents of each and every file and directory is stored to device 24. For an incremental backup, the contents of only those files that have a last-changed date that is newer than the corresponding last-change date for the respective files determined from the parent backup index are stored. If a file is located by the file structure scan that was not present in the parent backup index, the file is deemed to be new and backed up accordingly. If the content of a file is not backed up, an “unchanged” flag (i.e. attribute) therefor is included in the new incremental backup's index. This attribute is useful for a future restore to indicate that processing the immediate parent backup (at least) will be necessary in order to restore that file.

The backup index including the attribute information noted in the scan process and backup storing process is also stored to backup storage device 24. Further, dependency data structure 40 is updated to account for the new backup, adding a dependent node to the appropriate parent node for an incremental backup or establishing a new parent node for a full backup as is applicable. Signals representative of the tree structure data 40 are preferably stored on backup storage device 24. Though a backup of the entire primary storage device 22 is described, it is understood that the backup process may be configured to store only selected files or not backup selected files and directories in accordance with criteria established by user intervention or set by default configuration.

The backup procedure preferably includes a verification step similar to a full restore of the current backup, reading a portion of each file backed up but without restoring any of the files to the primary storage device 22. When verifying, a small header portion at the beginning of each file copied to the backup may be evaluated to determine whether the file begins at the offset into the backup indicated by the index for the backup. The offset may be determined in accordance with a file size stored in the index for the files stored in the backup. Verification is performed primarily as a redundancy check and to evaluate any hardware failures. Once a backup is verified, it maybe marked as such. A backup that does not pass verification (because it failed or because the process was interrupted by user intervention or a power outage) is preferably not used as a parent backup.

The management process manages the backups stored on the backup storage device 24 in accordance with preferences that balance the desire for granularity (i.e. the availability of many backups) and the available storage space. For example, during operation of the backup process, should the backup storage device 24 have insufficient storage space remaining to store a new backup, one or more recorded backups are automatically pared by the management process to permit continued operation of the backup process. The management process determines from the backup tree structure 40 which backups to pare according to the following general guidelines.

When choosing a backup to delete, at least one old full backup, i.e. one or more monthly backups should be maintained. Further, fine granularity for recent backups, (i.e. micro backup period) should be maintained, if possible. Between the two extremes of recent to old backups, the preference for fine granularity generally decreases and thus older incremental backups may be pared according to preferences. One preference may be to automatically delete a micro backup once it is more than 7 days old, even if available storage device space is plentiful. A further preference may be to maintain a certain number of weekly backups and eliminate older daily backups.

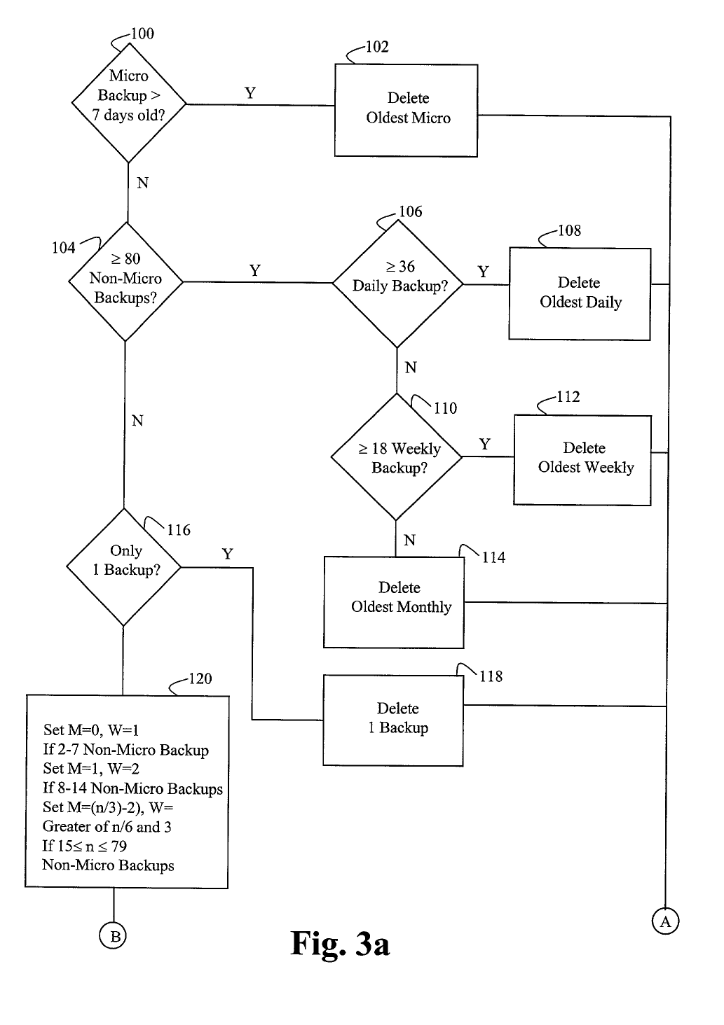

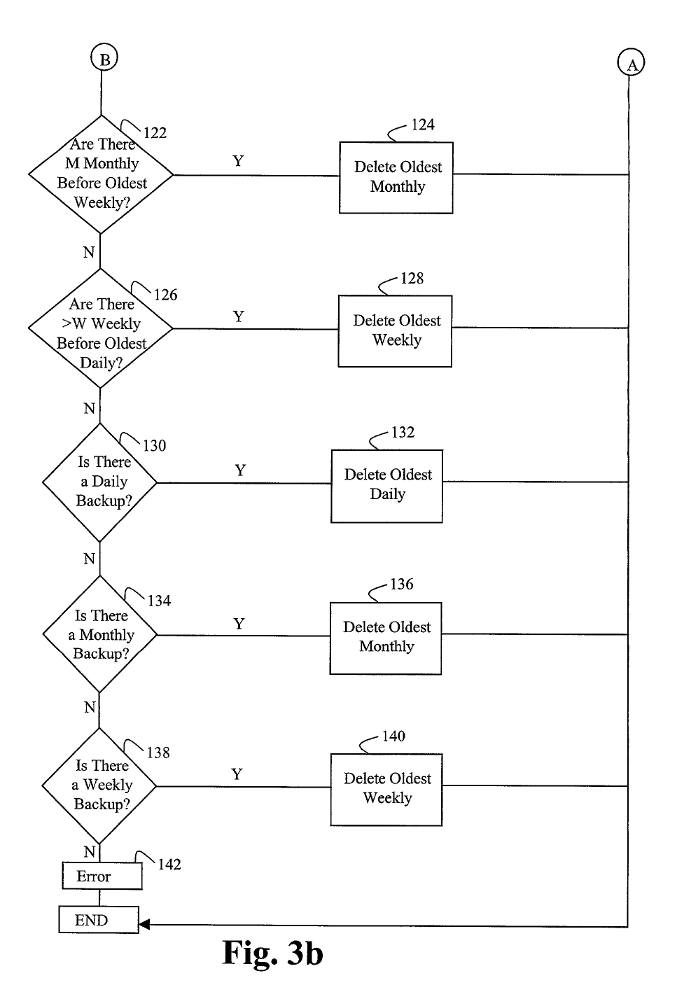

A preferred manner for choosing a backup to pare is illustrated in flow chart form in FIGS. 3a and 3b. At step 100, the tree structure generated during the backup process is examined to determine whether there is a micro backup more than 7 days (i.e. a week) old. If there is such a micro backup, it is pared from the tree structure and backup storage device 24. Otherwise, at step 104, a determination is made whether there are 80 or more backups, not including micro backups. If so, at step 106, a further determination is made whether at least 36 are daily backups (i.e. there are at least 6 weeks of daily backups stored). In such a case, the first (i.e. oldest) daily backup may be pared (step 108). If there are fewer than 36 daily backups, at step 110 a determination is made whether there are 18 or more weekly backups (i.e. 6 months of weekly backups). At step 112, the oldest weekly backup is pared. Otherwise, at step 114 the oldest monthly backup is pared.

At step 116, if there are fewer than 80 backups (not including micro backups), it is determined whether there is only a single backup. In such a case, only one backup will likely ever fit. The one backup is pared at step 118 to free the needed space for an immediate backup and preferably a notification is made to an operator that adoption of a larger backup storage device and/or media should be considered.

Otherwise and without regard to any micro backups, at step 120 the following operations are performed:

If there are at least 2 and at most 7 backups, set M=0, W=1;

If there are at lest 8 and at most 14 backups, set M=1, W=2; and

If the number of backups ‘n’ satisfies (15<=n<=79), set M=(n/3)−2, and W=greater of n/6 and 3.

If the number of monthly backups that pre-date the oldest weekly back up is greater than M as defined above (step 122), the oldest monthly is pared at step 124. Otherwise, if there are more than W weekly backups that predate the oldest daily backup (step 126), the oldest weekly is pared at step 128. Failing which, at step 130 a determination is made whether there is a daily backup to delete. At step 132 the oldest such daily is pared if present. Otherwise, at step 134 a determination is made whether there is a monthly available for paring. If so, at step 136 the oldest is pared. Failing which, at step 138 the tree structure is examined for a weekly backup. If available, at step 140 the oldest weekly backup is pared. Otherwise, an error result may be notified (step 142).

In general, the preferred manner of managing the backup data keeps six weeks of daily backups, six months of weekly backups, and as many monthly backups as will fit on backup storage device 24. If the amount of storage space provided by device 24 permits the storage of only a relatively few backups (i.e. between 2 and 7 backups) before there is insufficient space to add an additional backup, the management process is configured to preserve a month's worth of backups, if possible. If the amount of space on device 24 permits a moderate number of backups to be stored (i.e. between 8 to 14 backups), a balance of the three main types (monthly, weekly and daily) is maintained. Otherwise, the management process operates to keep, with reference to the number of non-micro backups stored, one third monthly backups at the beginning, one sixth weekly backups after that, and then the regular mix of mostly daily backups.

The above description assumes there are no unverified backups stored to backup device 24. If there are one or more unverified backups present, they are preferably deleted before deleting a verified backup.

With up to 96 incremental backups scheduled for each day on a 15-minute micro backup interval, restoring files could potentially be tedious work for a user. In accordance with a restore process of the invention, restoring data at the level of any particular incremental backup automatically restores appropriate data from the list of parent backups too.

Since the backup process is configured to perform a full backup upon a first use of a backup storage media, each backup storage device always contains a complete, consistent backup set. Thus, even if a plurality of backup media are used in a rotational scheme, typically in combination with off-site storage of the backup media not presently in use, as is well understood to those skilled in the art, any one backup media may be used to fully restore the primary storage device to the date of the most recent backup on the media. Further, following a rotation of the media, the first backup will be an incremental, based on a backup that is already present on the media disk, rather than based on the last backup performed with the prior media. Conveniently, a backup storage media employed in the backup and management processes of the invention will always permit a full restore.

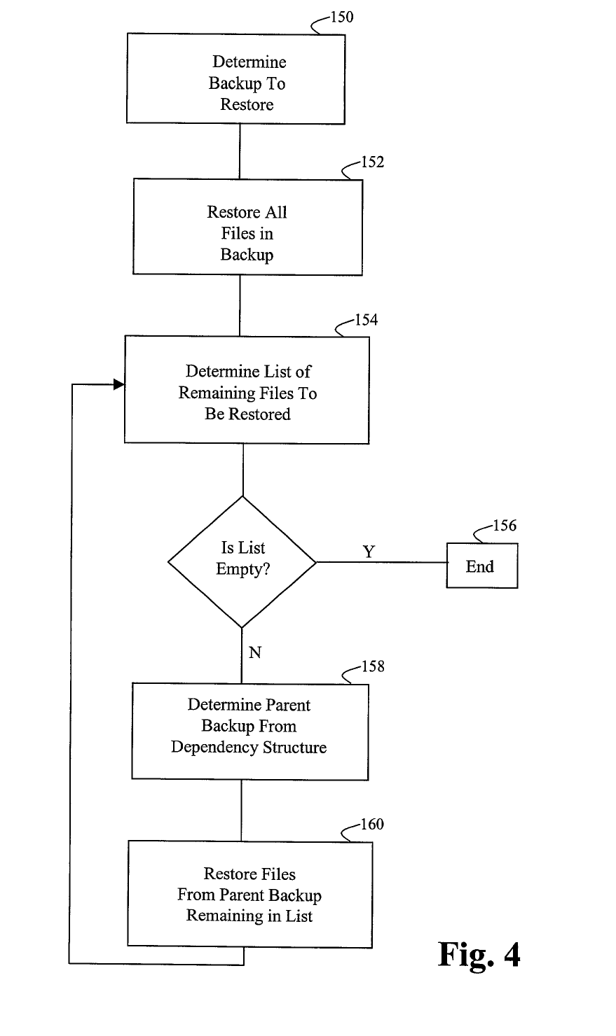

The restore process is configured to operate as follows and as illustrated in flow chart form in FIG. 4. While a restore process is usually performed to restore data to the same storage device from which it was originally copied (i.e. a first device) the restore process may be configured to copy the data to be restored to another storage device (i.e. a second device coupled to the computer system (not shown)). Thus, persons skilled in the art understand that the second device may comprise the first device.

At step 150 the backup to restore is determined. The restore process is described with reference to the restore of an incremental backup and it is understood that similar operations may be performed to restore a full backup. The determination of the appropriate backup to restore may be initiated via a user interface, preferably a graphical interface (GUI), as is understood to a person skilled in the art, to permit an operator to choose a particular incremental backup, in whole or in part.

Alternatively, a default may be configured within the restore procedure directing the restore of the most current backup automatically following initiation of the restore procedure. The restore may be initiated by a user command via a GUI or other computer interface or through hardware means such as a control button (not shown) configured to control processor 12. Similarly, the backup process may also be commenced in accordance with user demand by an appropriately configured control button (not shown) or user interface.

As previously described, each backup contains a list of all files present on the primary storage device at the time of the backup. The list further indicates which of those files were not copied to the backup storage device since they were not changed or new. In step 152, once the incremental backup to be restored is determined, the restore procedure restores each file identified to be restored that is present in the particular incremental backup. In step 154, a list of remaining files and/or directories to be restored is prepared. Conveniently, the “unchanged” attribute facilitates this preparation. In step 156, if the list is empty, the restore procedure stops. In step 158, if the list is not empty, the parent backup of the backup just restored is determined from the tree structure and opened. In such a case, every file or directory present in the parent backup and identified in the list of remaining files is restored to the primary storage device in step 160. Following the restore of the parent backup, similar operations are performed for the items remaining in the list of files and directories with respect to a parent backup as indicated by a return to step 154. The restore procedure eventually terminates at step 156 since the files indicated to be restored will either be located in the one or more incremental backups or the root monthly backup linked in the tree structure.

In order to have sufficient capacity for storing full and incremental backups to provide desired granularity and convenience of backup and restore while balancing other considerations such as cost, applicant has determined that a backup storage device that is generally 1.5 times larger than the primary storage device is sufficient. Of course, persons skilled in the art will appreciate that the capacity of the backup storage device may be chosen with reference to the anticipated use of the primary storage device to be backed up. A backup storage device that is suitable for backing up a primary storage device used as a server for a plurality of users in a small office business environment will likely be different from a backup device for a similar server environment which maintains one or more very large files that may be frequently change. Small office business users typically have relatively small files compared to the capacity of the primary storage device. Graphics/animation files for a multimedia shop or database files are often much larger. Primarily, desired backup capacity depends upon an anticipated frequency of file change and addition and the size of the changed and added files, preferably the size following compression, among other factors.

Conveniently, micro backups increase the ability of a user to retrieve a desired version of a file. For example, if a user worked on a file from 9:00 AM to 1:20 PM and the file was lost due to inadvertence or system error, then a restore from a 1:15 PM micro backup can be performed with a loss of about 5 minutes work. In accordance with the preferred management procedure for paring backups, for a short-term recovery period of about 7 days, a user can generally find a backup with almost exactly the file or file version desired. When the present invention is implemented on a small enterprise server system for a business office environment, since not very much usually changes on such a server in 15 minutes, the incremental backups are generally very small. Unless a majority of the files on the server are continuously undergoing changes or the files are very large relative to the capacity of the primary storage device, the anticipated space to be used by these 15 minute backups is a small fraction of the available capacity of the backup storage device.

Preferably, the backup medium is a hard disk or other high speed read and write device and preferably of a selectively removable variety. The speed of such a medium makes it possible to do backups every 15 minutes. Removable drive trays for hard disks facilitates conventional rotation and off-site storage of media, often associated with tape backups.

The embodiment(s) of the invention described above is(are) intended to be exemplary only. The scope of the invention is therefore limited solely by the scope of the appended claims.

I claim:

1. A method of data backup of data stored in a first storage device coupled to a computer system, comprising steps of:
a) storing to a backup storage device coupled to the computer system at least one full backup, each full backup comprising a copy of said data selected from the first storage device in accordance with a first criteria and attribute data representative of attributes of the selected data;
b) storing to the backup storage device zero, one or more incremental backups, each incremental backup comprising a copy of said data selected from the first storage device in accordance with the first criteria and a second criteria and attribute data representative of attributes of the selected data, said second criteria determined in relation to a parent backup comprising one of a selected full backup and incremental backup previously stored to the backup storage device; and
c) storing parent data representative of the relationship of each incremental backup to its respective parent backup in a dependency data structure.

2. The method as claimed in claim 1 comprising:
periodically performing steps b) and c) in accordance with two or more time intervals and respective second criteria to store different incremental backup types to provide different data granularity.

3. The method as claimed in claim 1 wherein the storing of step c) comprises storing the data dependency structure to the backup storage device.

4. The method as claimed in claim 3 wherein the backup storage device is operable with a one or more storage media and wherein the method comprises the steps of:
d) providing at least two storage media; and
e) performing steps a), b) and c) using said at least two storage media in a rotational manner; and
wherein, for each incremental backup to be stored to a one of the storage media, the second criteria is determined in relation to a parent backup stored to the one of the storage media.

5. The method as claimed in claim 1 wherein the dependency data structure is a tree-like data structure.

6. The method as claimed in claim 1 including the step of:
verifying the storing of the selected data stored to the backup storage device.

7. The method as claimed in claim 1 including the step of:
paring at least one of a full and incremental backup at the backup storage device automatically in accordance with a plan to manage the full and incremental backups.

8. The method as claimed in claim 7 wherein the plan is configured to manage an amount of available storage space at the backup storage device.

9. The method as claimed in claim 2 including the step of:
paring at least one of a full and incremental backup at the backup storage device automatically to manage the full and incremental backups in accordance with an amount of available storage space at the backup storage device.

10. The method as claimed in claim 1 including the steps of:
identifying a backup stored to the backup storage device comprising data to be restored to a second storage device coupled to the computer system, said backup defining a current backup;
copying the data to be restored to the second storage device from the data stored to the current backup; and
repeating until all the data to be restored is copied to the second storage device:
determining the portion of said data to be restored remaining to be copied;
determining a parent backup to the current backup from the dependency data structure said parent backup redefining the current backup; and
where the data stored to the current backup comprises any of the portion of said data to be restored remaining to be copied, copying the any of the portion of data to the second storage device from the current backup.

11. A computer system comprising
a processing means;
means for coupling the processing means to a first data storage device, the first storage device comprising data to be backed up, said data having a first characteristic;
means for coupling the processing means to a backup data storage device;
said processing means configured to:
storing to the backup storage device at least one full backup, each full backup comprising a copy of said data selected from the first storage device in accordance with a first criteria and attribute data representative of attributes of the selected data;
storing to the backup storage device zero, one or more incremental backups, each incremental backup comprising a copy of said data selected from the first storage device in accordance with the first criteria and a second criteria and attribute data representative of attributes of the selected data, said second criteria determined in relation to a parent backup comprising one of a selected full backup and incremental backup previously stored to the backup storage device; and
storing a parent data representative of the relationship of each incremental backup to its respective parent backup in a dependency data structure.

12. The system as claimed in claim 11 wherein the processing means is configured to:
periodically perform steps b) and c) in accordance with two or more time intervals and respective second criteria to store different incremental backup types to provide different data granularity.

13. The system as claimed in claim 11 wherein the processing means is configured to storing the dependency data structure to the backup storage device.

14. The system as claimed in claim 13 wherein the backup storage device is operable with a one or more storage media and wherein the processing means is configured to:
for each incremental backup to be stored to a one of the storage media, determine the second criteria in relation to a parent backup stored to the one of the storage media to permit the use of at least two storage media in a rotational manner.

15. The system as claimed in claim 11 wherein the dependency data structure is a tree-like data structure.

16. The system as claimed in claim 11 wherein the processing means is configured to:
pare at least one of a full and incremental backup at the backup storage device automatically in accordance with a plan to manage the full and incremental backups.

17. The system as claimed in claim 16 wherein the plan is configured to manage an amount of available storage space at the backup storage device.

18. The system as claimed in claim 12 wherein the processing means is configured to:
pare at least one of a full and incremental backup at the backup storage device automatically to manage the full and incremental backups in accordance with an amount of available storage space at the backup storage device.

19. The system as claimed in claim 12 comprising means for coupling the computer system to a second storage device and wherein the processing means is configured to:
identify a backup stored to the backup storage device comprising data to be restored to the second storage device, said backup defining a current backup;
copy the data to be restored to the second storage device from the data stored to the current backup; and
repeat until all the data to be restored is copied to the second storage device:
determining the portion of said data to be restored remaining to be copied;
determining a parent backup to the current backup from the dependency data structure, said parent backup redefining the current backup; and
where the data stored to the current backup comprises any of the portion of said data to be restored remaining to be copied, copying the any of the portion of data to the second storage device from the current backup.

20. A computer readable medium containing executable program instructions for backing up data from a first storage device to a backup storage device, said devices coupled to a computer system, the computer readable medium comprising program instructions for directing the computer system to implement the method of claim 1.
